(19) United States
(12) Patent Application Publication
(10) Pub. No.: US 2012/0006664 A1
(43) Pub. Date: Jan. 12, 2012

(54) Push switch

(76) Inventors: Takahisa Kitahara, Isesaki-shi (JP); Atsushi Ichimura, Isesaki-shi (JP)

(21) Appl. No.: 13/065,985

(22) Filed: Apr. 4, 2011

(30) Foreign Application Priority Data
Jul. 7, 2010 (JP) 2010-154683

(51) Int. Cl. H01H 13/14

(52) U.S. Cl. 200/341

(57) ABSTRACT

Disclosed is a push switch wherein a flexible button is fitted on top of a case which houses a switch that is disposed on a mount. The mount comprises, integrally formed from resin, a base portion on which the switch is mounted; a cover portion, which is formed higher than a main body part of the switch, on the top face of the base portion, and surrounds the periphery of the main body part; and a stopper portion, which is formed on the bottom face of the base portion, and latches on the inside of the case.

### BACKGROUND OF THE INVENTION

1. Field of the Invention

The present invention relates to a push switch using a flexible button.

2. Description of the Related Art

For example, Japanese Patent Laid-Open Publication No. 2009-146806 describes, as shown in FIG. 5, a push switch 110 comprising a base 111, a switch board 116 and a switch main body 112 disposed on the base 111, a key top 114 disposed on the switch main body 112, and a case 115, which houses the switch main body 112 so that a portion of the key top 114 protrudes, an elastic engagement member 113 being provided between the switch main body 112 and the key top 114, which is in close contact with the inner peripheral face of the case 115 and holds the key top 114.

Furthermore, Japanese Patent Laid-Open Publication No. 2004-327126 describes a push switch for locking or unlocking a vehicle door which, as shown in FIG. 6, is fitted in an outside door handle 125 of a vehicle door lock device, wherein a switch 123 that is pushed by a boss portion 122 of a flexible button 121 is covered by a switch cap 124.

This switch cap 124 is fitted into the peripheral edge of an opening in a switch case 126, which is fixed in the outside handle 125. A switch plate 127 is further fitted on this switch case 126.

With this push switch, when the button 121 is pushed by a user, a thin portion 131 of the button 121 is deformed, whereby the boss portion 122 pushes the switch 124, and the switch 123 is pushed by this pushing force, so as to turn the switch on.

With a push switch such as shown in FIG. 5, there is a problem in so much as, if the key top 114 is pushed with excessive force, it is possible that the elastic engagement member 113 will be damaged as a result of fissures resulting from undue elongation of the thin portions of the elastic engagement member 113, and as a result of the bottom face of the elastic engagement member 113 contacting the corners of the switch main body 112, so that the durability and reliability is inferior.

Furthermore, if the top key 114 is pushed with excessive force, an excessive force will act on the switch main body 112 and the switch board 116, and there is a risk of these breaking.

Furthermore, the switch main body 112 is mounted on the switch board 116, and a base 111 serving to support the switch board 116 is further provided in the case 115, which increases the number of parts, and thus raises the cost.

Meanwhile, with the push switch in FIG. 6, if the flexible button 121 is pushed with excessive force, an end face 128 of the button 121 bears against an end face 129 of the switch plate 127 and the pressing load is transmitted to the bottom part of the switch case 126 and is relieved to the load bearing portion 130 of the outside handle 125, which abuts the switch case 126, so that the excessive load does not act on the switch 123.

However, if the button 121 is pushed with an excessive load obliquely from above as seen in the drawing, there is a risk of the thin portion 131 and the boss portion 122 being damaged as a result of fissures, due to the thin portion 131 of the button 121 being unduly elongated and the thin portion 131 and the boss portion 122 of the button 121 contacting the corners of the opening in the switch plate 127.

Furthermore, the switch 123 is mounted on the board 132, and the switch plate 127 is further provided in order that excessive loads do not act on the switch 123, which increases the number of parts, and thus raises the cost.

In addition, there were problems in that, because the button 121 and the switch case 126 are completely separated, the push switch lacks general-purpose versatility, and the production characteristics are inferior because, when this is mounted, it is necessary to align the button 121 and the switch case 126.

### SUMMARY OF THE INVENTION

Thus, an object of the present invention is to provide a highly durable and reliable push switch, while reducing the number of parts.

The push switch of the present invention comprises: a mount 40; a switch 30, which is disposed on said mount, having a main body part 32, an actuation part 31 that protrudes upward from said main body part, and a terminal 33; a tubular case 10, which houses said mount and said switch; and a flexible button 20, which is fitted on the top of said case, and has a bottom face that faces said actuation part of said switch, wherein, said mount 40 comprises, integrally formed from resin: a base portion 41 on which said switch 30 is mounted; a cover portion 42, which is formed higher than said main body part of said switch, on the top face of said base portion, and surrounds the periphery of said main body part; and a stopper portion 43, which is formed on the bottom face of said base portion, and latches on the inside of said case.

Further preferred characteristics of the push switch of the present invention include the cover portion 42 which is formed with the top corner portion curved and with a space with respect to the inside of the button. A terminal member 45 is mounted on the bottom face of the base portion 41 and a lead wire 50 is connected to the terminal member 45. The terminal 33 of the switch 30 is connected to the terminal member 45 and the cover portion 42 is lower than the top of the actuation part 31.

With the push switch of the present invention, the periphery of the main body part (32) of the switch (30) is surrounded by the cover portion (42), which is higher than the main body portion (32), whereby excessive force can be effectively prevented from acting on the switch, so as to produce a push switch having excellent durability and reliability. Furthermore, by using a mount (40) in which the base portion (41) on which the switch is mounted, the cover portion (42), which surrounds the periphery of the main body part of the switch, and the stopper portion (43) are integrally formed, the durability and reliability of the push switch can be improved without increasing the number of parts.

Furthermore, in the push switch of the present invention, if the corners at the top of the cover portion (42) are formed curved, and the cover portion (42) is formed with a space provided with respect to the inside of the button 20, it is possible to effectively prevent damage to the flexible button (20) which is pushed.

### BRIEF DESCRIPTION OF THE DRAWINGS

FIG. 1 is a top view of a push switch according to one mode of embodiment of the present invention.

FIG. 2 is a bottom view of a push switch according to the first mode of embodiment of the present invention.

FIG. 3 is a sectional view of a push switch according to one mode of embodiment of the present invention, wherein (a) is a sectional view along the line A-A in FIG. 1, and (b) is a sectional view along the line B-B in FIG. 1.

FIG. 4 is a sectional view serving to describe the operation of the push switch according to the first mode of embodiment of the present invention.

FIG. 5 is a sectional view of a conventional push switch.

FIG. 6 is a sectional view of another conventional push switch.

### DESCRIPTION OF THE PREFERRED EMBODIMENTS

Hereafter, embodiments of the present invention are described based on the drawings.

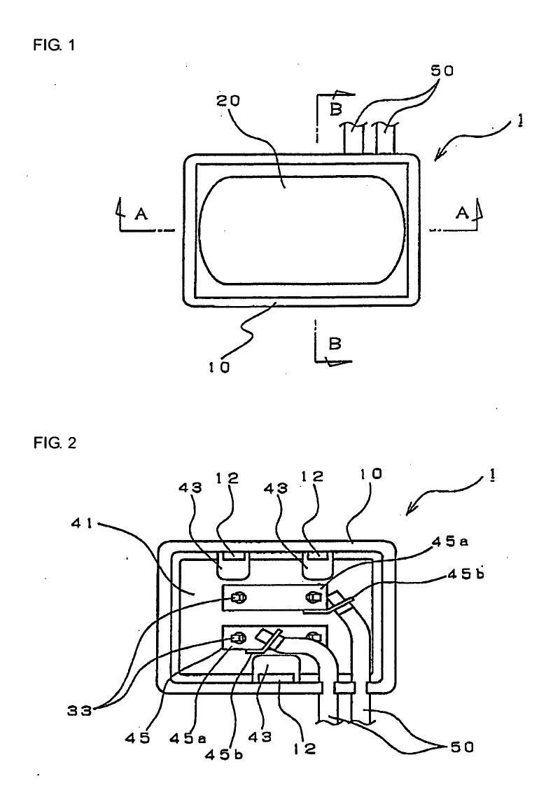

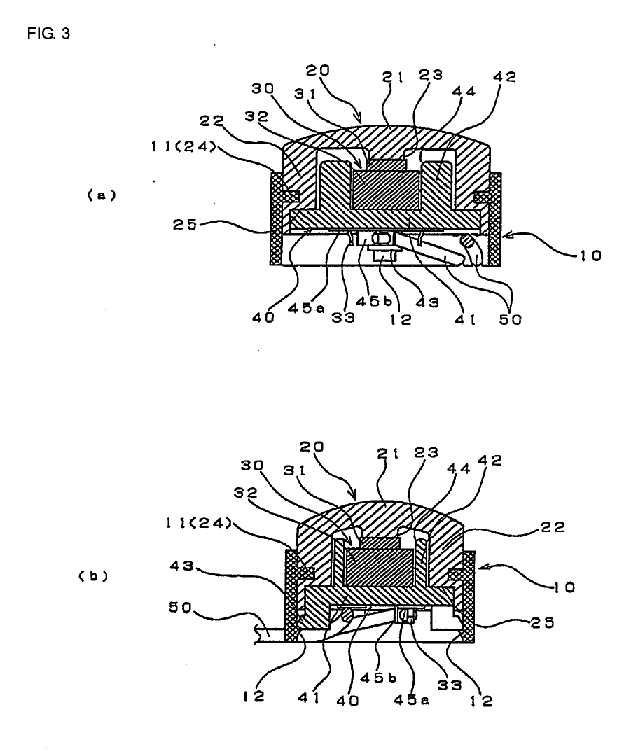

FIG. 1 to FIG. 3 show a push switch 1 according to one mode of embodiment of the present invention, wherein FIG. 1 is a top view, FIG. 2 is a bottom view, FIG. 3(a) is a sectional view along the line A-A in FIG. 1, and FIG. 3(b) is a sectional view along the line B-B in FIG. 1.

The push switch 1 of this example is mounted in a vehicle door handle device, which is not shown in the drawing. When a user operates a door lock device, a button 20 of the push switch 1 that is exposed by the vehicle door handle device is pushed, whereby the door can be locked or unlocked.

This push switch 1 comprises a case 10, a button 20, a switch 30, a mount 40, and lead wires 50.

The case 10 is integrally formed in a tubular shape from a hard resin, and has an engagement projection 11 at the upper interior, and latching claws 12 at the lower interior.

Note that the engagement projection 11 is formed along the entire inner circumference, and the latching claws 12 are formed in three places.

The button 20 is formed from an elastically flexible resin, such as rubber, and comprises a top actuation wall 21 and, descending vertically from the peripheral edge thereof, a peripheral side wall 22, having an opening at the bottom.

An actuation protrusion 23 is provided on the bottom of the top actuation wall 21, in the center thereof. Furthermore, an engagement recess 24 and a stepped portion 25 are provided on the peripheral side wall 22.

This button 20 is fitted in the case 10 so that the engagement recess 24 fits over the engagement projection 11 on the case 10.

Note that, when the push switch 1 is mounted on a door handle, which is not shown in the drawing, this is fitted inside the door handle so that the top actuation wall 21 of the button 20 is exposed to the exterior.

The switch 30 has a cylindrical actuation part 31, a rectangular prism shaped main body part 32 and terminals 33. The actuation part 31 protrudes upwards from the interior of the main body part 32, being configured so as to be mobile in the vertical direction as seen in FIG. 3, and being biased in the upward direction as seen in FIG. 3, by an elastic member at the interior of the main body part 32, which is not shown in the drawing.

This switch 30 is mounted on the mount 40, and the switch 30 and the mount 40 are housed within the case 10.

The mount 40 is integrally formed from a hard resin and comprises a planar base portion 41 on which the switch 30 is mounted, a cover portion 42 which is formed on the top face of the base portion 41, and stopper portions 43, which are formed on the bottom face the base portion 41.

The cover portion 42 surrounds the periphery of the main body part 32 of the switch 30, along the sides of the main body part 32.

The top of the cover portion 42 is higher than the top of the main body part 32 and is ordinarily (when the push switch is not being pushed) lower than the top of the actuation part 31.

Furthermore, the corner portions 44 at the top of the cover portion 42 are formed as outwardly convex gradual curves. Note that the cross-sectional shape of the corner portion 44 does not have to be a perfectly circular arc, and elliptical arcs and chamfered corners may be included as corner portions formed as curves.

The stopper portions 43 are provided in three locations corresponding to the latching claws 12 on the case 10, so that each of these latches with a latching claw 12.

Thus, the mount 40 is fixed in place within the case 10 with the peripheral edge of the base portion 41 fitted into the stepped portion 25 of the button 20. Furthermore, the cover portion 42 is provided with a predetermined space (gap) with respect to the inside of the button 20, and the actuation protrusion 23 on the button 20 faces the actuation part 31 of the switch 30, in proximity thereto or in contact therewith.

Electroconductive terminal members 45 are mounted on the bottom face of the base portion 41.

These terminal members 45 comprise planar portions 45a and connection parts 45b, which are erected at predetermined positions on the planar portions 45a.

The terminals 33 of the switch 30 lead downward via through-holes that are provided in the base portion 41 and the planar portions 45a, and are electrically connected to the planar portions 45a by way of solder the like.

Furthermore, lead wires 50 are electrically connected to the connection parts 45b of the terminal members 45, and these lead wires 50 lead out to the exterior of the case 10.

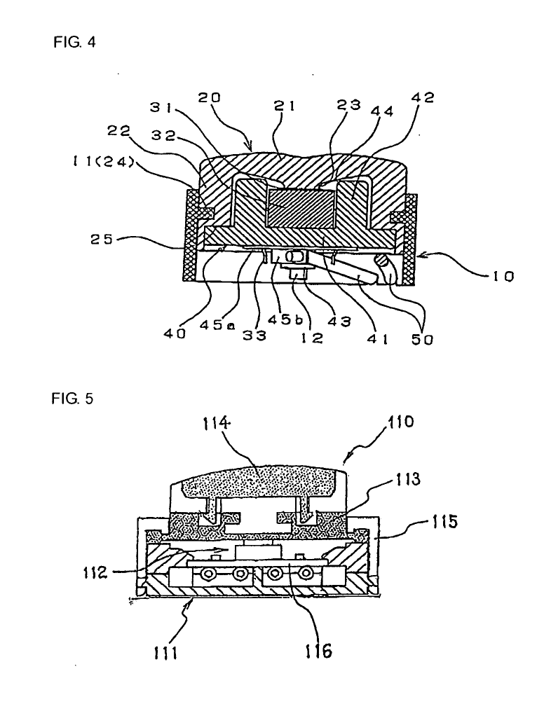

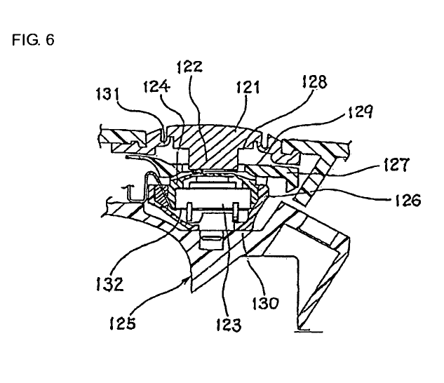

With the push switch 1 according to this example, which is configured as described above, if the top actuation wall 21 of the button 20 is pushed downwards from above as seen in FIG. 3(a), the top actuation wall 21 is elastically deformed as shown in FIG. 4, so that the actuation protrusion 23 pushes the actuation part 31 downwards, the switch 30 is turned on, and a signal is transmitted to the exterior by the lead wires 50.

At this time, if the button 20 is pushed with excessive force, the inside of the top actuation wall 21 will bear against the top of the cover portion 42, which is higher than the main body part 32 of the switch 30, but because the top corner portions 44 of the cover portion 42 are formed in a predetermined curved shape, the inside of the button 20 will not be damaged and tearing of the flexible button 20 can be effectively prevented.

Furthermore, because the stroke of the button 20 is limited by the cover portion 42, it is possible to prevent excessive loads from being applied to the switch 30. In other words, if the button 20 is pushed with an excessive force, the inner face of the button 20 bears against the cover portion 42 and the pressing load is transmitted to the case 10 via the base portion 41 and the stopper portions 43, which are formed integrally with the cover portion 42, whereby the excessive load does not act directly on the switch 30.

Thus, with the push switch according to this example, because the periphery of the main body part 32 of the switch 30 is surrounded by the cover portion 42, which is higher than the main body part 32, and the top corner portion 44 of this cover portion 42 is formed as a curve, it is possible to effectively prevent damage to the button 20, and to effectively prevent excessive force from acting on the switch 30, and thus the durability and reliability of the push switch are excellent.

Furthermore, if the switch is disposed on a printed circuit board or a flexible board, as was conventional, it is necessary to separately provide a stopper member to support such boards, but with the push switch according to the present example, it is possible to improve durability and reliability without increasing the number of parts by using the mount 40, wherein the base portion 41 on which the switch 30 is mounted, the cover portion 42, which receives excessive loads and limits the stroke of the button 20, and the stopper portion 43 that functions as a stopper, are integrally formed from resin.

Furthermore, with the push switch according to this example, the top of the cover portion 42 is normally (when the push switch is not being pushed) lower than the top of the actuation part 31.

With such a configuration, it is possible to effectively limit the height of the overall push switch while maintaining a stroke sufficient for the switch 30 to be turned on.

Note that, with the push switch of the present invention, it is particularly preferable that the distance between the top actuation wall 21 of the button 20 and the cover portion 42 be established at approximately equal to the distance of the stroke with which the switch 30 is turned on when the button 20 is pressed. Consequently, when the button 20 is pressed, the inside of the top actuation wall 21 will strike the cover portion 42 at substantially the same time as the switch 30 is turned on, so that no more load than is necessary will be applied to the switch 30, whereby it is possible to more reliably protect the switch. In addition, the hard cover portion 42 serves to limit excessive deformation of the flexible button 20, allowing for more reliable prevention of tearing due to excessive deformation of the flexible button 20, so as to further improve durability.

In the foregoing, a mode of embodiment of the present invention has been described, but the present invention is not limited to such a mode of embodiment, and it is a matter of course that suitable modifications and the like can be made without departing from the gist thereof.

Specifically, for example, in the mode of embodiment described above, the entire side face of the main body part 32 of the switch is surrounded by the cover portion 42, which is formed in a continuous tubular shape, but the cover portion 42 may also be formed divided into a number of segments, so long as this is a mode wherein the inside of the button 20 will not bear against the main body part 32 even if the button 20 is pushed with excessive force.

Furthermore, in the mode of embodiment described above, an actuation protrusion 23 is provided on the bottom of the button 20, but the actuation protrusion 23 does not necessarily have to be provided in a mode wherein the bottom of the button 20 pushes the actuation part 31 downward, so that the switch 30 can be turned on.

What is claimed is:

1. A push switch comprising:
a mount;
a switch means disposed on said mount and having a main body part, an actuation part that protrudes upward from said main body part and a terminal;
a tubular case which houses said mount and said switch means and
a flexible button which is fitted on a top of said case and has a bottom face that faces said actuation part,
wherein said mount comprises, integrally formed from resin: a base portion on which said switch means is mounted; a cover portion which is formed higher than said main body part of said switch means, on a top face of said base portion, and surrounds a periphery of said main body part; and a stopper portion which is formed on a bottom face of said base portion, and latches on an inside of said case.

2. The push switch according to claim 1 wherein
said cover portion is formed with a top corner portion curved and with a space with respect to an inside of said button.

3. The push switch according to claim 1, comprising
a terminal member mounted on the bottom face of said base portion; and
a lead wire which is connected to said terminal member,
wherein said terminal of said switch means is connected to said terminal member.

4. The push switch according to claim 1, wherein
said cover portion is lower than a top of said actuation part.

5. The push switch according to claim 2, wherein
said cover portion is lower than a top of said actuation part.

6. The push switch according to claim 3, wherein
said cover portion is lower than a top of said actuation part.
